(19) United States
(12) Patent Application Publication
(10) Pub. No.: US 2014/0132252 A1
(43) Pub. Date: May 15, 2014

(54) WIRING STRUCTURE OF DISPLACEMENT SENSOR

(71) Applicant: MITSUBISHI HEAVY INDUSTRIES, LTD., Tokyo (JP)

(72) Inventor: Kazunari IZAWA, Tokyo (JP)

(73) Assignee: MITSUBISHI HEAVY INDUSTRIES, LTD., Tokyo (JP)

(21) Appl. No.: 14/039,862

(22) Filed: Sep. 27, 2013

(30) Foreign Application Priority Data
Nov. 12, 2012 (JP) 2012-248025

(51) Int. Cl. G01B 7/14; G01B 7/30

(52) U.S. Cl. CPC G01B 7/14; G01B 7/30
USPC 324/207.17

(57) ABSTRACT

Coil patterns and connecting wirings of a slider part or the like are prepared using a printed board (slider board). Connecting wiring patterns prepared using the printed board are arranged at multiple layers. The coil patterns and the connecting wiring patterns are connected via through-holes.

### TECHNICAL FIELD

The present invention relates to a wiring structure of a displacement sensor which detects the amount of displacement by means of electromagnetic induction.

### BACKGROUND ART

Inductosyn sensors are well known as this type of displacement sensor (see Patent Literature 1 and the like, for example). The inductosyn sensors generally include: a scale part formed of an inductosyn board provided with a flat coil pattern on one surface; and a slider part disposed slidably and formed of an inductosyn board provided with a flat coil pattern on its surface facing the scale part. As alternating current is caused to flow through the coil pattern on one inductosyn board, voltage is induced by electromagnetic induction across the coil pattern on the other inductosyn board, with which the amount of displacement of a detection target is detected.

Note that in Patent Literature 1 and the like, the inductosyn boards are formed in a multilayer structure in which exactly the same coil pattern as the coil pattern on the front surface is formed on an inner layer directly at the back of the coil pattern on the front surface. By combining electromagnetic fields generated around there two coil patterns, the inductosyn sensor's electromagnetic induction is accelerated without having to increase the alternating current that is caused to flow through the inductosyn boards, thereby improving the detection accuracy.

Meanwhile, FIG. 4 shows a conventional example of a single-layer slider board in a slider part of a displacement sensor. This is obtained by: attaching a copper foil onto a coil pattern surface 101a of a blank board (slider board) 100 and directly developing and creating coil patterns (not shown); and connecting the coil patterns through hand soldering using twisted wirings (see a group of twisted wirings 102) via many wiring holes, grooves, and the like formed in the blank board 100. Note that reference signs 103 in the drawing denote attachment holes penetrating from the coil pattern surface 101a to a blank board attachment surface 101b.

### CITATION LIST

### Patent Literature

{Patent Literature 1} Japanese Patent Application Publication No. Hei 11-83545

### SUMMARY OF INVENTION

### Technical Problems

However, since the blank board 100 in the conventional slider part mentioned above involves attaching a copper foil onto the coil pattern surface 101a and directly developing and creating coil patterns, etching is needed in addition to the developing operation, thereby causing a problem of increased man-hour. Moreover, since the blank board 100 involves connecting the coil patterns through hand soldering using twisted wirings (see the group of twisted wirings 102), a trained operator needs to perform the operation, and also the number of blank machining processes for wiring holes, grooves, and the like increases, thereby causing a problem of increased cost.

Moreover, since the coil patterns are connected by using twisted wirings (see the group of twisted wirings 102), the group of twisted wirings 102 forms a protrusion on the coil pattern surface 101a. This may possibly limit the gap between the coil pattern surface 101a and a coil pattern surface of a scale facing it, cause interference with some other object, and so on.

In view of the above, an object of the present invention is to provide a wiring structure of a displacement sensor which can greatly reduce the man-hour in its manufacturing process, thereby achieving cost reduction, and also eliminate the protrusion by wirings.

### Solution to Problems

A wiring structure of a displacement sensor according to the present invention for achieving the above object is a wiring structure of a displacement sensor which detects a relative position between a slider part of a linear scale and a scale part of the linear scale or a relative position between a stator part of a rotary scale and a rotor part of the rotary scale by means of electromagnetic induction, wherein

coil patterns and connecting wirings of the slider part or the stator part are prepared using a printed board, the connecting wiring being given between the coil patterns,

connecting wiring patterns prepared using the printed board are arranged at a plurality of layers, and

the coil patterns and the connecting wiring patterns are connected via through-holes.

Moreover, the connecting wiring patterns are arranged in the corresponding layers in such away as to overlap each other in a thickness direction of the printed board.

Moreover, the wiring structure includes at least two series of the coil patterns and the connecting wiring patterns, and

in the two series, a pattern width of the connecting wiring patterns is set approximately three to five times greater than a pattern width of the coil patterns.

### Advantageous Effects of Invention

In the wiring structure of a displacement sensor according to the present invention, the coil patterns and the connecting wiring patterns of the slider part or the like are prepared using a printed board. Accordingly, it is possible to greatly reduce the man-hour in the manufacturing process, thereby achieving cost reduction, and realize mass production, and also to eliminate protrusion by wirings which would occur if twisted wirings are used to connect the coil patterns.

Moreover, since the connecting wiring patterns are arranged in the corresponding layers in such a way as to overlap each other in the thickness direction of the printed board, it is possible to cancel out signal interference in the connecting wiring patterns and thus to enhance the detection accuracy as well.

Moreover, since in the two series, the pattern width of the connecting wiring patterns is set at least three times greater than the pattern width of the coil patterns, it is possible to reduce the manufacturing error in the resistance of each of the connecting wiring patterns and thus to enhance the detection accuracy.

### BRIEF DESCRIPTION OF DRAWINGS

FIG. 1 is a diagram describing patterns on a slider board in a linear scale showing one embodiment of the present invention.

FIG. 2A is likewise a diagram describing connecting wiring patterns at a third layer.

FIG. 2B is likewise a diagram describing connecting wiring patterns at a second layer.

FIG. 2C is likewise a diagram describing connecting wiring patterns at a first layer.

FIG. 3 is a flowchart showing a method of fabricating the slider board.

FIG. 4 is a diagram describing a blank board of a slider part in a conventional linear scale.

### DESCRIPTION OF EMBODIMENTS

Hereinbelow, a wiring structure of a displacement sensor according to the present invention will be described in detail through an embodiment with reference to the drawings.

### Embodiments

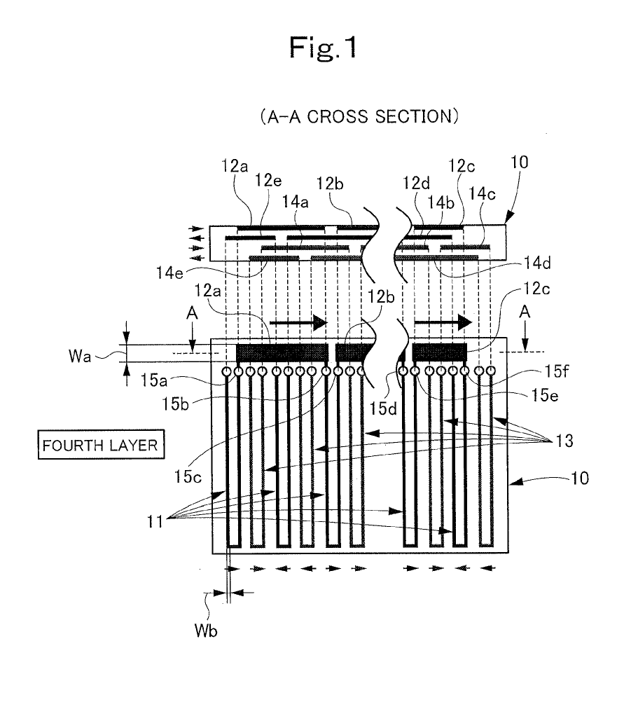

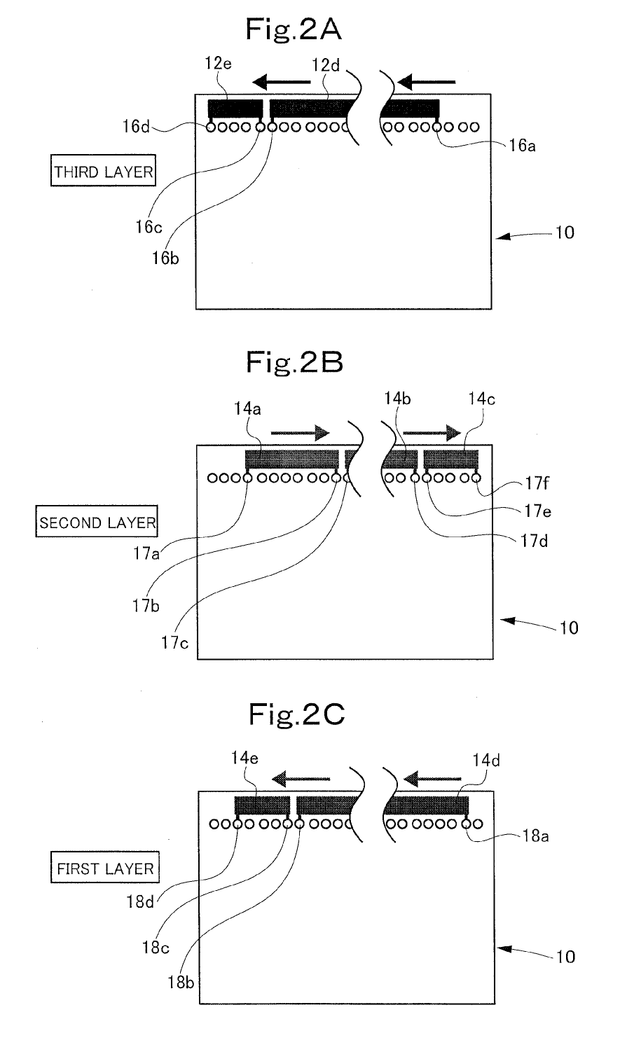

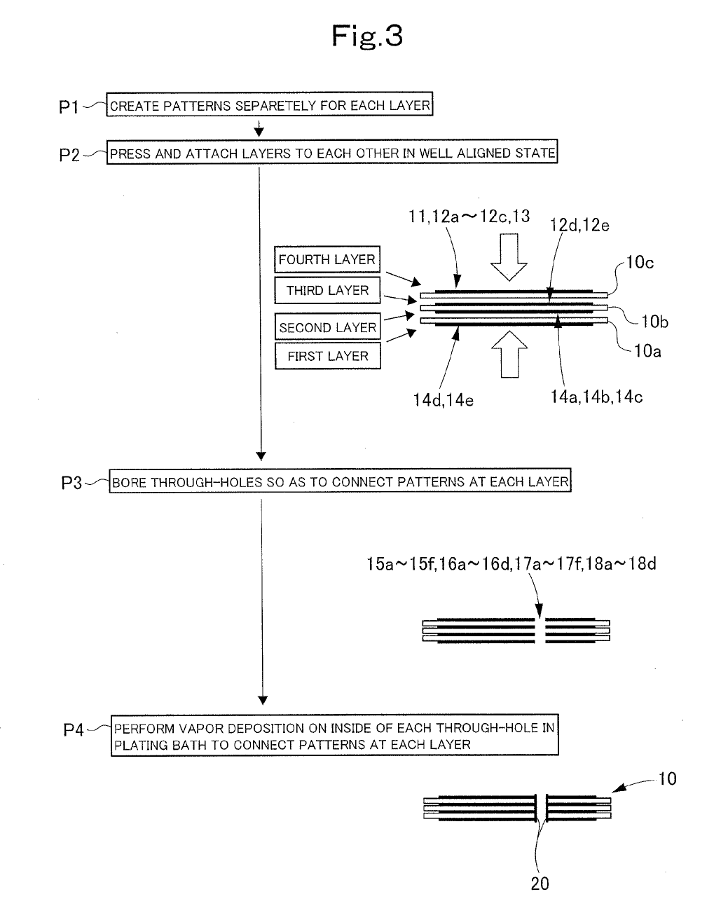

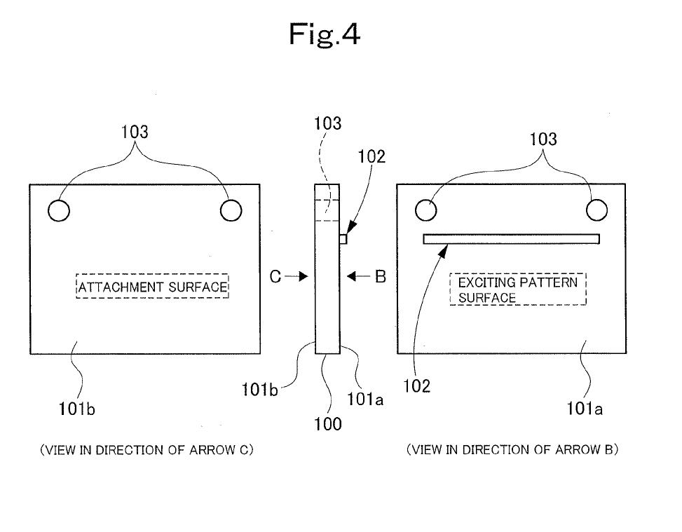

FIG. 1 is a diagram describing patterns on a slider board in a linear scale showing one embodiment of the present invention. FIG. 2A is likewise a diagram describing connecting wiring patterns at a third layer. FIG. 2B is likewise a diagram describing connecting wiring patterns at a second layer. FIG. 2C is likewise a diagram describing connecting wiring patterns at a first layer. FIG. 3 is a flowchart showing a method of fabricating the slider board.

As shown in FIG. 1, a slider board 10 in a slider part of the linear scale includes two series of patterns which are: a SIN pattern formed of many (e.g. 48) square U-shaped coil patterns 11 and many (e.g. 24) connecting wiring patterns 12a to 12e connecting the coil patterns 11; and a COS pattern formed of many (e.g. 48) square U-shaped coil patterns 13 and many (e.g. 24) connecting wiring patterns 14a to 14e connecting the coil patterns 13.

Moreover, the coil patterns 11 and 13 and the connecting wiring patterns 12a to 12e and 14a to 14e are prepared using a printed board. Of the patterns, the connecting wiring patterns 12a to 12e and 14a to 14e are arranged at multiple layers (first to fourth layers in the illustrated example).

Specifically, at the fourth layer which is the front surface of the slider board 10, there are arranged: the coil patterns 11 and 13 of the SIN pattern and the COS pattern; and the connecting wiring patterns 12a to 12c of the SIN pattern which are located above the coil patterns 11 and 13 and through which electric current flows in one direction (from left to right in FIG. 1). Moreover, at the third layer, only the connecting wiring patterns 12d and 12e of the SIN pattern are arranged through which electric current flows in the other direction (from right to left in FIG. 2A). Furthermore, at the second layer, only the connecting wiring patterns 14a to 14c of the COS pattern are arranged through which electric current flows in the one direction (from left to right in FIG. 2B). Lastly, at the first layer, only the connecting wiring patterns 14d and 14e of the COS pattern are arranged through which electric current flows in the other direction (from right to left in FIG. 2C).

Moreover, the coil patterns 11 and 13 of the SIN pattern and the COS pattern are connected to the connecting wiring patterns 14d and 14e, 14a to 14c, 12d and 12e, and 12a to 12c of the SIN pattern and the COS pattern, arranged at the first to fourth layers, via through-holes 18a to 18d, 17a to 17f, 16a to 16d, and 15a to 15f (see FIG. 3) which penetrate the slider board 10 in the thickness direction thereof.

Specifically, in the SIN pattern, the connecting wiring pattern 12a is connected to the through-holes 15a and 15b, the connecting wiring pattern 12b is connected to the through-holes 15c and 15d, the connecting wiring pattern 12c is connected to the through-holes 15e and 15f, the connecting wiring pattern 12d is connected to the through-holes 16a and 16b, and the connecting wiring pattern 12e is connected to the through-holes 16c and 16d. In the COS pattern, the connecting wiring pattern 14a is connected to the through-holes 17a and 17b, the connecting wiring pattern 14b is connected to the through-holes 17c and 17d, the connecting wiring pattern 14c is connected to the through-holes 17e and 17f, the connecting wiring pattern 14d is connected to the through-holes 18a and 18b, and the connecting wiring pattern 14e is connected to the through-holes 18c and 18d.

Moreover, the connecting wiring patterns 14d and 14e, 14a to 14c, 12d and 12e, and 12a to 12c of the SIN pattern and the COS pattern arranged at the first to fourth layers are arranged in their corresponding layers in such a way as to overlap each other in the thickness direction of the slider board 10.

Furthermore, the connecting wiring patterns 14d and 14e, 14a to 14c, 12d and 12e, and 12a to 12c of the SIN pattern and the COS pattern arranged at the first to fourth layers have a pattern width Wa which is set approximately three to five times greater than a pattern width Wb of the coil patterns 11 and 13 of the SIN pattern and the COS pattern.

Note that the slider board 10 configured as described above can be manufactured using a general method of fabricating a printed board as shown in FIG. 3.

Specifically, in step P1, the patterns are formed separately for each layer. Here, the connecting wiring patterns 14d and 14e of the first layer are attached to the back surface of an insulating material 10a, the connecting wiring patterns 14a to 14c of the second layer are attached to the back surface of an insulating material 10b, the connecting wiring patterns 12e and 12d of the third layer are attached to the front surface of the insulating material 10b, and the coil patterns 11 and 13 and the connecting wiring patterns 12a to 12c of the fourth layer are attached to the front surface of an insulating material 10c.

Then, in step P2, the layers are pressed and attached to each other in a well aligned state. Thereafter, in step P3, the through-holes 15a to 15f, 16a to 16d, 17a to 17f, and 18a to 18d are bored with a drill or the like so as to connect the patterns at each layer.

Lastly, in step P4, vapor deposition is performed on the inside of each through-hole in a plating bath to thereby connect the patterns at each layer (see conductive portions 20). As a result, the slider board 10 is completed.

Since the slider board 10 is configured as described above, electric current flows at given moments in the directions of arrows in FIGS. 1 and 2A to 2C when alternating current is caused to flow in the coil patterns 11 and 13 of the SIN pattern and the COS pattern and the connecting wiring patterns 14d and 14e, 14a to 14c, 12d and 12e, and 12a to 12c of the SIN pattern and the COS pattern arranged at the first to fourth layers by use of a power supply not shown.

As a result, voltage is generated across coil patterns in a scale part not shown due to electromagnetic induction. Then, as the positions of the slider part and the scale part change, the generated voltage changes, and this change is captured to detect the positions.

Since the coil patterns 11 and 13 and the connecting wiring patterns 12a to 12e and 14a to 14e of the slider part or the like are prepared using a printed board, it is possible to greatly reduce the man-hour in the manufacturing process (development, etching, wiring, etc.), thereby achieving cost reduction, and realize mass production, and also to eliminate protrusion by wirings which would occur if twisted wirings are used to connect the coil patterns.

Moreover, since the connecting wiring patterns 12a to 12e and 14a to 14e are arranged in the first to fourth layers in such a way as to overlap each other in the thickness direction of the slider board 10, it is possible to cancel out signal interference in the connecting wiring patterns 12a to 12e and 14a to 14e and thus to enhance the detection accuracy as well.

Moreover, since, in the two series, the pattern width Wa of connecting wiring patterns 12a to 12e and 14a to 14e is set at least three times greater than the pattern width Wb of the coil patterns 11 and 13, it is possible to reduce the manufacturing error in the resistance of each of the connecting wiring patterns 12a to 12e and 14a to 14e and thus to enhance the detection accuracy.

Further, it is needless to say that the present invention is not limited to the embodiment described above and that various changes such as changing the number of patterns of each type and the number of layers and increasing or decreasing the number of series can be made without departing from the gist of the present invention. Furthermore, although the present invention is applied to a slider board of a linear scale, the present invention can be applied also to a stator board of a rotary scale.

### INDUSTRIAL APPLICABILITY

The wiring structure of a displacement sensor according to the present invention can greatly reduce the man-hour in its manufacturing process, thereby achieving cost reduction, and eliminate protrusion by wirings, and can therefore be used preferably for inductosyn sensors for various types of machine tools.

### REFERENCE SIGNS LIST

10 Slider Board
10a to 10c Insulating Material
11 Coil Pattern of SIN Pattern
12a to 12e Connecting Wiring Pattern of SIN Pattern
13 Coil Pattern of COS Pattern
14a to 14e Connectin Wiring Pattern of COS Pattern
15a to 15f Through-Hole of SIN Pattern
16a to 16d Through-Hole of SIN Pattern
17a to 17f Through-Hole of COS Pattern
18a to 18d Through-Hole of COS Pattern
20 Vapor Deposition Portion
Wa Pattern Width of Connecting Wiring Pattern
Wb Pattern Width of Coil Pattern

1. A wiring structure of a displacement sensor which detects a relative position between a slider part of a linear scale and a scale part of the linear scale or a relative position between a stator part of a rotary scale and a rotor part of the rotary scale by means of electromagnetic induction, wherein
coil patterns and connecting wirings of the slider part or the stator part are prepared using a printed board, the connecting wiring being given between the coil patterns,
connecting wiring patterns prepared using the printed board are arranged at a plurality of layers, and
the coil patterns and the connecting wiring patterns are connected via through-holes.

2. The wiring structure of a displacement sensor according to claim 1, wherein the connecting wiring patterns are arranged in the corresponding layers in such a way as to overlap each other in a thickness direction of the printed board.

3. The wiring structure of a displacement sensor according to claim 1, wherein
the wiring structure includes at least two series of the coil patterns and the connecting wiring patterns, and
in the two series, a pattern width of the connecting wiring patterns is set approximately three to five times greater than a pattern width of the coil patterns.

4. The wiring structure of a displacement sensor according to claim 2, wherein
the wiring structure includes at least two series of the coil patterns and the connecting wiring patterns, and
in the two series, a pattern width of the connecting wiring patterns is set approximately three to five times greater than a pattern width of the coil patterns.
